(19) United States
(12) Patent Application Publication
(10) Pub. No.: US 2026/0204807 A1
(43) Pub. Date: Jul. 16, 2026

(54) CONNECTOR AND HOLDING PORTION

(71) Applicant: Yazaki Corporation, Tokyo (JP)

(72) Inventors: Kei SATO, Shizuoka (JP); Motonori MIYANARI, Shizuoka (JP); Kimihiro ABE, Shizuoka (JP); Takuya OTAKE, Shizuoka (JP)

(73) Assignee: Yazaki Corporation, Tokyo (JP)

(21) Appl. No.: 19/443,650

(22) Filed: Jan. 8, 2026

(30) Foreign Application Priority Data
Jan. 15, 2025 (JP) 2025-005689
Jun. 4, 2025 (JP) 2025-093483

(51) Int. Cl. H01R 4/18

(52) U.S. Cl. CPC H01R 4/182

(57) ABSTRACT

A connector includes a pair of inner terminals respectively connected to an inner conductors of the pair of electric wires, an inner housing collectively covering a pair of inner terminals, an outer terminal covering the inner housing, and a holding portion integrally provided with a cable holding portion that holds the outer insulator, and a twisted wire holding portion that collectively holds the inner insulators of the pair of electric wires exposed from a distal end of the outer insulator of the twisted cable.

### CROSS-REFERENCE TO RELATED APPLICATIONS

This application is based on and claims priority under 35 USC 119 from Japanese Patent Applications No. 2025-005689 filed on January 15, 2025 and No. 2025-093483 filed on June 4, 2025, the contents of which are incorporated herein by reference.

### TECHNICAL FIELD

The present disclosure relates to a connector and a holding portion.

### BACKGROUND ART

In the related art, a twisted cable includes a twisted wire including a pair of electric wires, and an outer insulator covering the twisted wire. The electric wire includes an inner conductor and an inner insulator covering the inner conductor. In a connector used for such a twisted cable, a crimping member that holds the outer insulator is accommodated in a housing of the connector (see, for example, Patent Literature 1).

### CITATION LIST

### PATENT LITERATURE

Patent Literature 1: JP2021-51846A

### SUMMARY OF INVENTION

In the connector disclosed in Patent Literature 1, the crimping member holds the outer insulator, but does not hold the inner insulator. That is, the connector of Patent Literature 1 does not have a structure in which the twisted wire and the outer insulator are integrally held, and when the outer insulator is pulled in a direction away from the connector, there is a possibility that a contact margin of the twisted wire with respect to a terminal of another connector cannot be maintained.

The present disclosure has been made in view of the above circumstances, and an object thereof is to provide a connector and a holding portion capable of maintaining a contact margin of a twisted wire even when an outer insulator is pulled in a direction away from the connector.

In order to achieve the above object, a connector according to the present disclosure is characterized as follows. The connector to be attached to an end of a twisted cable includes a twisted wire having a pair of electric wires, and an outer insulator covering the twisted wire. The electric wire includes an inner conductor and an inner insulator covering the inner conductor. The connector includes a pair of inner terminals respectively connected to the inner conductors of the pair of electric wires, an inner housing collectively covering the pair of inner terminals, an outer terminal covering the inner housing, and a holding portion integrally provided with a cable holding portion that holds the outer insulator, and a twisted wire holding portion that collectively holds the inner insulators of the pair of electric wires exposed from a distal end of the outer insulator of the twisted cable.

Further, in order to achieve the above object, a holding portion according to the present disclosure is characterized as follows. The holding portion to be attached to an end of a twisted cable includes a twisted wire having a pair of electric wires, and an outer insulator covering the twisted wire. The electric wire includes an inner conductor and an inner insulator covering the inner conductor. The holding portion is integrally provided with a cable holding portion that holds the outer insulator, and a twisted wire holding portion that collectively holds the inner insulators of the pair of electric wires exposed from a distal end of the outer insulator of the twisted cable.

According to the connector and the holding portion of the present disclosure, the contact margin of the twisted wire can be maintained even when the outer insulator is pulled in the direction away from the connector.

The present disclosure has been briefly described above. Further, the details of the present disclosure can be clarified by reading modes (hereinafter, referred to as "embodiments") for carrying out the invention described below with reference to the accompanying drawings.

### BRIEF DESCRIPTION OF DRAWINGS

FIG. 1 is an exploded perspective view illustrating a connector and a holding portion according to a first embodiment;

FIG. 2 is a side view illustrating a twisted cable;

FIG. 3 is a perspective view illustrating a holding portion;

FIG. 4 is a perspective view illustrating a state in which the holding portion is crimped;

FIG. 5 is a cross-sectional view illustrating the twisted cable, an inner terminal, an inner housing, and an outer terminal;

FIG. 6 is a perspective view illustrating a state in which the inner terminal is inserted into the inner housing;

FIG. 7 is a perspective view illustrating a state in which the inner housing is inserted into the outer terminal;

FIG. 8 is a perspective view illustrating the connector according to the embodiment of the present disclosure;

FIG. 9 is a perspective view illustrating a holding portion according to a second embodiment;

FIG. 10 is a perspective view illustrating a state in which the holding portion is crimped according to the second embodiment;

FIG. 11 is a cross-sectional view of the holding portion according to the second embodiment;

FIG. 12 is a perspective view illustrating a holding portion according to a third embodiment;

FIG. 13 is a perspective view illustrating a state in which the holding portion is crimped according to the third embodiment;

FIG. 14 is a cross-sectional view illustrating the holding portion according to the third embodiment;

FIG. 15 is a perspective view illustrating a holding portion according to a fourth embodiment;

FIG. 16 is a perspective view illustrating a state in which the holding portion is crimped according to the fourth embodiment; and

FIGS. 17A to 17C are diagrams illustrating a process of crimping the holding portion according to the fourth embodiment.

### DESCRIPTION OF EMBODIMENTS

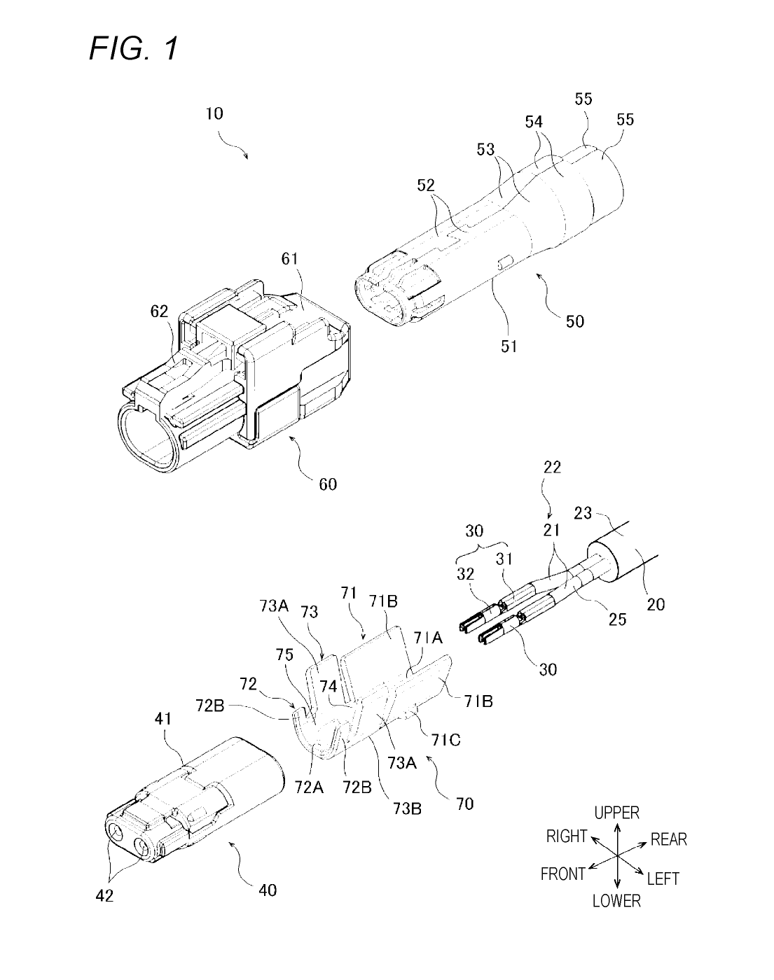

Hereinafter, a connector and a holding portion according to an embodiment of the present disclosure will be described with reference to the drawings. Hereinafter, for convenience of description, a "front-rear direction", a "left-right direction", and an "up-down direction" are defined as illustrated in FIGS. 1 to 16. The "front-rear direction", the "left-right direction", and the "up-down direction" are orthogonal to each other. The "left-right direction" corresponds to a "width direction" of the present disclosure.

### First Embodiment

First, a connector 10 of a first embodiment will be described. As illustrated in FIG. 1, the connector 10 includes a pair of inner terminals 30, an inner housing 40, an outer terminal 50, an outer housing 60, and a ferrule 70 serving as a holding portion. The pair of inner terminals 30 are connected to a twisted cable 20. The inner housing 40 covers the inner terminals 30. The outer terminal 50 covers the inner housing 40. The outer housing 60 accommodates the outer terminal 50. The ferrule 70 is accommodated in the outer terminal 50, and the cable holding portion 71 and the twisted wire holding portion 72 are integrally provided.

### Twisted Cable 20

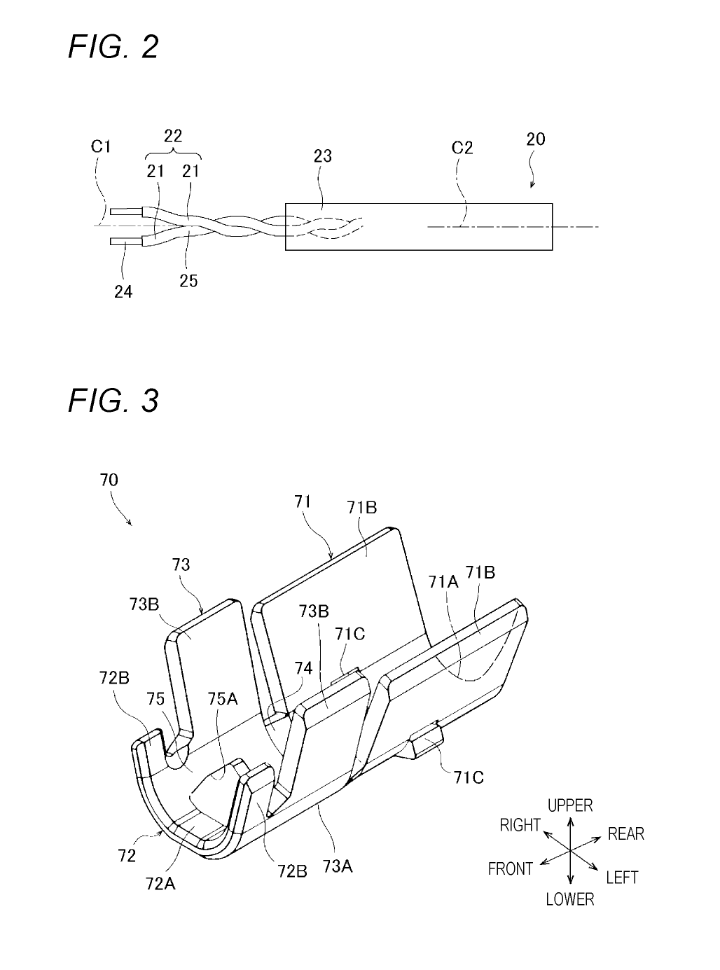

As illustrated in FIG. 2, the twisted cable 20 includes a twisted wire 22 including a pair of electric wires 21 and 21, and a cylindrical outer insulator 23 covering the twisted wire 22. The electric wires 21 each include an inner conductor 24, and an inner insulator 25 covering the inner conductor 24, and are spirally combined with each other. Such a twisted cable 20 is disposed such that an axis C1 connecting contact points of the electric wires 21 and 21 is coaxial with an axis C2 of the outer insulator 23.

The twisted cable 20 has a twisted wire 22 exposed by peeling off the outer insulator 23 at an end portion. In addition, the inner conductor 24 is exposed by peeling off the inner insulator 25 at an end portion of the exposed twisted wire 22.

### Inner Terminal 30

Returning to FIG. 1, the inner terminal 30 includes a crimping portion 31 to be crimped to the inner conductor 24 of the electric wire 21, and a connection portion 32 provided continuously on a front side of the crimping portion 31. The connection portion 32 has a substantially box shape, and is electrically connectable by inserting a flat plate-shaped male tab provided in another connector (not illustrated).

### Inner Housing 40

The inner housing 40 is provided with a substantially flat cylindrical body 41 capable of individually accommodating the inner terminals 30, and insertion holes 42 and 42 penetrating the body 41 in the front-rear direction. The insertion holes 42 and 42 are arranged side by side in the left-right direction, and accommodate inner terminals 30 and 30, respectively. The inner housing 40 is made of resin, and the inner terminals 30 are individually insulated.

### Outer Terminal 50

The outer terminal 50 includes a bottom plate 51, a pair of body pieces 52 and 52, a pair of conical pieces 53 and 53, a pair of crimping pieces 54 and 54 (third crimping pieces), and a pair of crimping pieces 55 and 55 (fourth crimping pieces). The bottom plate 51 is elongated in the front-rear direction. The pair of body pieces 52 and 52 are erected upward from both ends of the bottom plate 51 in the left-right direction. The pair of body pieces 52 and 52 are bent such that distal end surfaces thereof abut against each other. The bottom plate 51 and the pair of body pieces 52 and 52 have a substantially flat cylindrical shape, and accommodate the inner housing 40.

The pair of conical pieces 53 and 53 are provided on a rear side of the pair of body pieces 52 and 52, and erected upward from both ends of the bottom plate 51 in the left-right direction. The pair of conical pieces 53 and 53 are bent such that distal end surfaces thereof abut against each other. The bottom plate 51 and the pair of conical pieces 53 and 53 have a substantially cylindrical shape, and are provided such that a diameter increases toward a rear side.

The pair of crimping pieces 54 and 54 are provided on a rear side of the pair of conical pieces 53 and 53, and erected upward from both ends of the bottom plate 51 in the left-right direction. The pair of crimping pieces 54 and 54 are bent such that distal end surfaces thereof abut against each other. The bottom plate 51 and the pair of crimping pieces 54 and 54 have a substantially cylindrical shape.

The pair of crimping pieces 55 and 55 are provided on a rear side of the pair of crimping pieces 54 and 54, and erected upward from both ends of the bottom plate 51 in the left-right direction. The pair of crimping pieces 55 and 55 are bent such that distal end surfaces thereof abut against each other. The bottom plate 51 and the pair of crimping pieces 55 and 55 have a substantially cylindrical shape. A diameter of a cylinder formed by the bottom plate 51 and the pair of crimping pieces 55 and 55 is smaller than a diameter of a cylinder formed by the bottom plate 51 and the pair of crimping pieces 54 and 54.

In the outer terminal 50, after the inner housing 40 and the ferrule 70 to be described later are mounted on the bottom plate 51, the distal end surfaces of the pair of body pieces 52 and 52, the pair of conical pieces 53 and 53, the pair of crimping pieces 54 and 54, and the pair of crimping pieces 55 and 55 are crimped so as to abut against each other, thereby fixing the ferrule 70 at a predetermined location.

### Outer Housing 60

The outer housing 60 includes a substantially box-shaped body 61 capable of accommodating the outer terminal 50, and a locking claw 62 provided on the body and capable of being locked to a mating connector (not illustrated).

### Ferrule 70

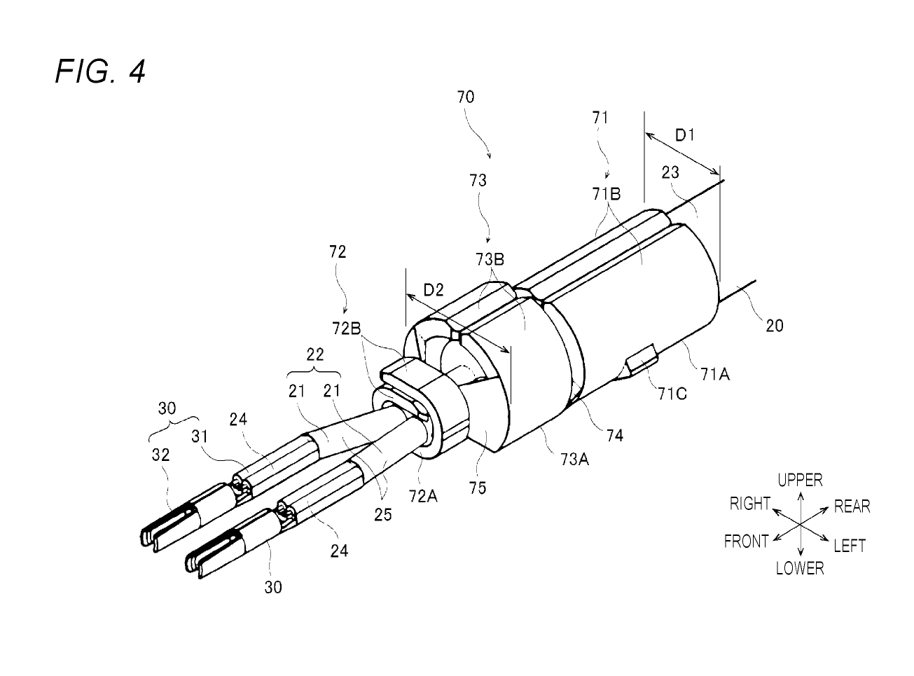

As illustrated in FIGS. 3 and 4, the ferrule 70 includes the cable holding portion 71, the twisted wire holding portion 72, a come-off prevention portion 73, a first coupling portion 74, and a second coupling portion 75. The cable holding portion 71 holds the outer insulator 23 of the twisted cable 20. The twisted wire holding portion 72 collectively holds the inner insulators 25 of the twisted cable 20. The come-off prevention portion 73 is provided between the cable holding portion 71 and the twisted wire holding portion 72, and prevents the ferrule 70 from coming off. The first coupling portion 74 is provided between the cable holding portion 71 and the come-off prevention portion 73, and couples the cable holding portion 71 and the come-off prevention portion 73. The second coupling portion 75 is provided between the twisted wire holding portion 72 and the come-off prevention portion 73, and couples the twisted wire holding portion 72 and the come-off prevention portion 73.

The cable holding portion 71 has a substantially U shape, including a bottom plate 71A as a first bottom plate on which the outer insulator 23 of the twisted cable 20 is mounted, and crimping pieces 71B and 71B as first crimping pieces that are erected from both sides of the bottom plate 71A in the left-right direction and crimp the outer insulator 23. In the cable holding portion 71, the crimping pieces 71B and 71B are crimped in a state in which the outer insulator 23 of the twisted cable 20 is mounted on the bottom plate 71A, and the bottom plate 71A and the crimping pieces 71B and 71B are crimped to a surface of the outer insulator 23 (see FIG. 4).

After the ferrule 70 is mounted on the bottom plate 51 of the outer terminal 50, the cable holding portion 71 is crimped by crimping the pair of crimping pieces 55 and 55 of the outer terminal 50. At this time, a relative position of the pair of crimping pieces 55 and 55 with respect to the cable holding portion 71 is fixed because engagement protrusions 71C and 71C protrude outside the bottom plate 71A.

The twisted wire holding portion 72 is provided on a front side of the cable holding portion 71. The twisted wire holding portion 72 has a substantially U shape, including a bottom plate 72A as a second bottom plate and crimping pieces 72B and 72B as a pair of second crimping pieces. The inner insulators 25 and 25 of the electric wires 21 and 21 are mounted on the bottom plate 72A in a state of being arranged side by side in the left-right direction. The pair of crimping pieces 72B and 72B are erected from both sides of the bottom plate 72A in the left-right direction and collectively crimp the inner insulators 25 and 25 of the electric wires 21 and 21.

The twisted wire holding portion 72 is crimped in a flat circular shape such that the crimping pieces 72B and 72B overlap in the up-down direction in a state in which the inner insulators 25 and 25 are mounted in parallel on the bottom plate 72A, and the bottom plate 72A and the crimping pieces 72B and 72B are crimped to surfaces of the inner insulators 25 and 25 (see FIG. 4).

The come-off prevention portion 73 is provided between the cable holding portion 71 and the twisted wire holding portion 72. The come-off prevention portion 73 has a substantially U shape, including a bottom plate 73A and crimping pieces 73B and 73B as a pair of third crimping pieces. The come-off prevention portion 73 is crimped such that distal end surfaces of the crimping pieces 73B and 73B approach each other (see FIG. 4). The come-off prevention portion 73 has an outer diameter dimension D2 that is larger than an outer diameter dimension D1 of the crimped cable holding portion 71. After the ferrule 70 is mounted on the bottom plate 51 of the outer terminal 50, the come-off prevention portion 73 is crimped by the crimping pieces 54 and 54 of the outer terminal 50.

The come-off prevention portion 73 has the outer diameter dimension D2 that is larger than the outer diameter dimension D1 of the cable holding portion 71. Therefore, even when the outer insulator 23 of the twisted cable 20 is pulled rearward after the ferrule 70 is accommodated in the outer terminal 50, the come-off prevention portion 73 is caught by the pair of crimping pieces 55 and 55 of the outer terminal 50, which crimp the cable holding portion 71, and the ferrule 70 can be prevented from coming off from the outer terminal 50.

The first coupling portion 74 couples the bottom plate 71A of the cable holding portion 71 and the bottom plate 73A of the come-off prevention portion 73. The first coupling portion 74, the bottom plate 71A, and the bottom plate 73A are provided in the same curved surface shape. The second coupling portion 75 is provided with a central hole 75A. The second coupling portion 75 is inclined so as to approach the axis C1 of the twisted cable 20 as approaching the twisted wire holding portion 72.

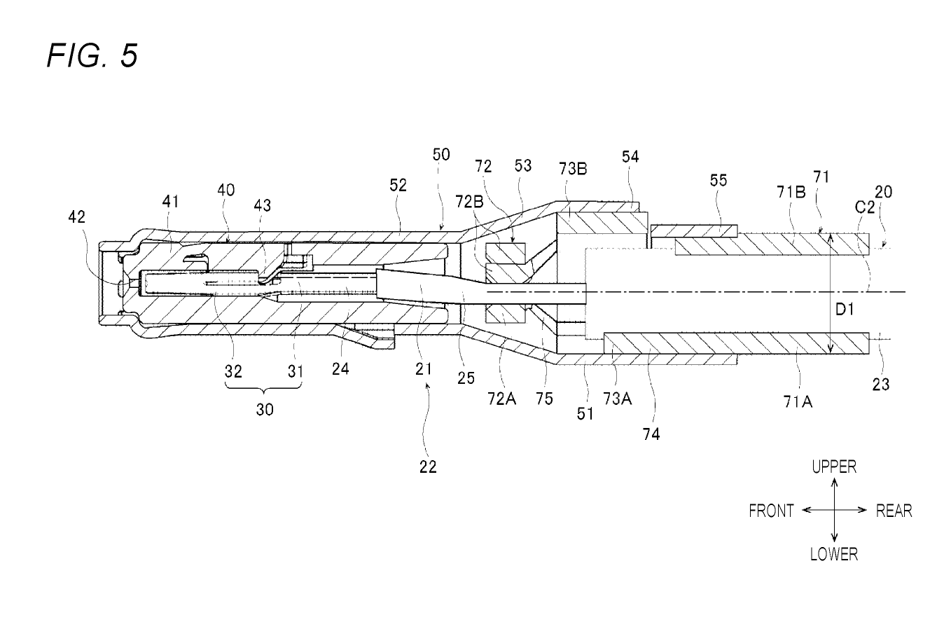

Accordingly, as illustrated in FIG. 5, in the ferrule 70, the bottom plate 72A is disposed at a position closer to the axis C1 of the twisted cable 20 than the bottom plate 71A. That is, the ferrule 70 is formed such that the cable holding portion 71 and the twisted wire holding portion 72 are crimped, and the axes C1 and C2 of the twisted cable 20 are coaxial even when the come-off prevention portion 73 is deformed.

### Assembling Procedure of Connector 10

Next, an assembly procedure of the connector 10 according to the embodiment of the present disclosure will be described. The inner terminals 30 and 30 are respectively attached to the inner conductors 24 and 24 of the twisted cable 20 (see FIG. 1), the outer insulator 23 is mounted on the bottom plate 71A of the ferrule 70, the inner insulators 25 and 25 of the electric wires 21 and 21 are mounted in parallel on the second bottom plate 72A, and the crimping pieces 71B and 71B of the cable holding portion 71, the crimping pieces 72B and 72B of the twisted wire holding portion 72, and the crimping pieces 73B and 73B of the come-off prevention portion 73 are crimped (see FIG. 4). Accordingly, the axes C1 and C2 of the twisted cable 20 are coaxial (see FIG. 5). A crimping step and a deformation step may be performed simultaneously or sequentially.

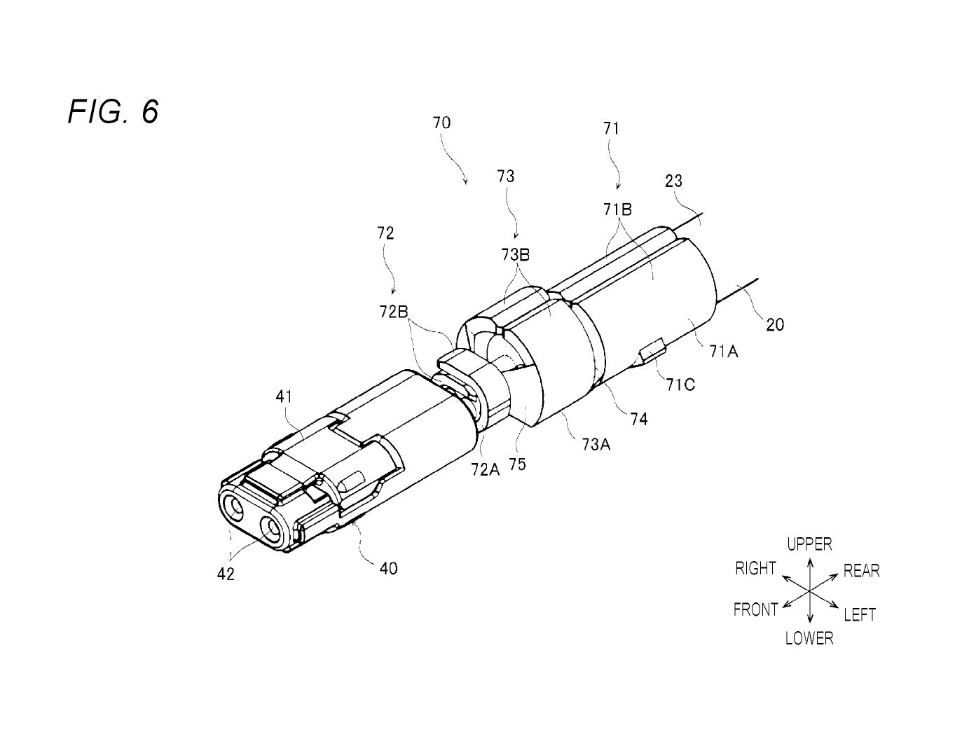

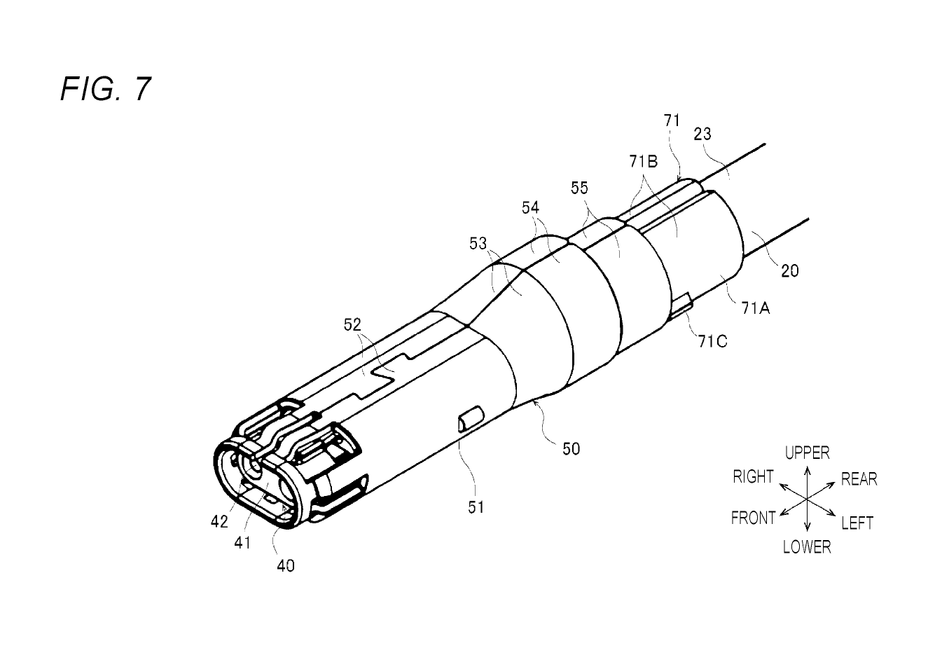

Next, as illustrated in FIG. 6, the inner terminals 30 and 30 are inserted into the inner housing 40, and a lance 43 (see FIG. 5) provided in the inner housing 40 is locked to the connection portion 32. Accordingly, the inner terminals 30 and 30 are accommodated in the inner housing 40 so as not to be pulled out. Subsequently, the inner housing 40 and the holding portion 70 are mounted on the bottom plate 51 of the outer terminal 50, and as illustrated in FIG. 7, the body pieces 52 and 52, the conical pieces 53 and 53, the crimping pieces 54 and 54, and the crimping pieces 55 and 55 are crimped. Accordingly, as illustrated in FIG. 5, the inner housing 40 is crimped by the body pieces 52 and 52 of the outer terminal 50. The come-off prevention portion 73 is crimped by the crimping pieces 54 and 54 of the outer terminal 50, and the cable holding portion 71 is crimped by the crimping pieces 55 and 55 of the outer terminal 50. Accordingly, the inner housing 40 and the outer terminal 50 are fixed to each other.

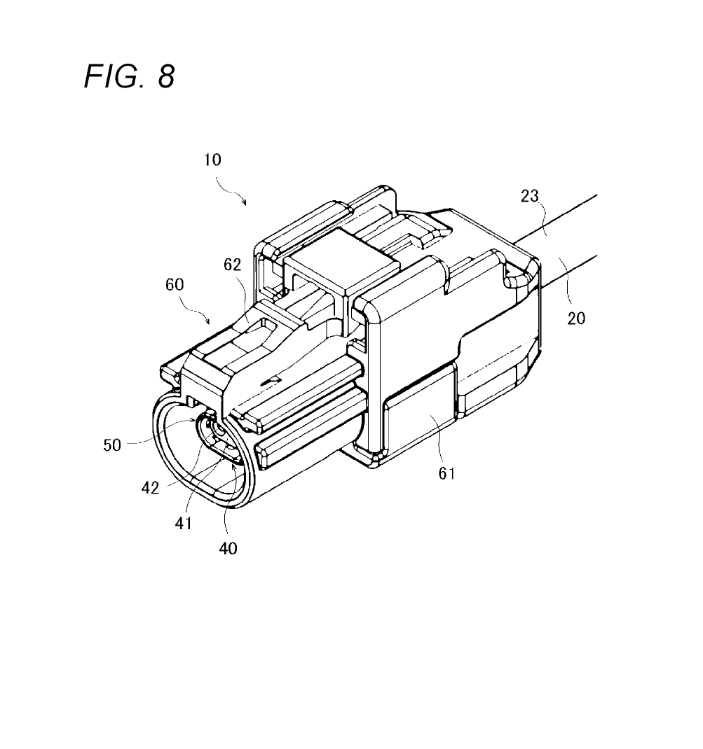

Then, as illustrated in FIG. 8, the outer terminal 50 is inserted into the outer housing 60 to obtain the connector 10. Such a connector 10 includes the ferrule 70 in which the cable holding portion 71 and the twisted wire holding portion 72 are integrated. Therefore, even when the outer insulator 23 of the twisted cable 20 is pulled rearward, the twisted cable 20 is not pulled locally, and the twisted cable 20 is pulled entirely. In particular, in the connector 10, the come-off prevention portion 73 is provided in the ferrule 70, and thus the ferrule 70 is firmly fixed to the outer terminal 50.

### Effects of First Embodiment

As described above, according to the connector 10 of the embodiment of the present disclosure, the cable holding portion 71 that holds the outer insulator 23, and the twisted wire holding portion 72 that collectively holds the inner insulators 25 are integrally provided by the ferrule 70, and thus, in other words, the twisted wire 22 and the outer insulator 23 are integrally held. Therefore, according to the connector 10 of the embodiment of the present disclosure, even when the outer insulator 23 is pulled in the direction away from the outer housing 60, a contact margin of the inner terminal 30 with respect to a terminal of another connector can be maintained, and thus the electrical connectivity can be reliably maintained as compared with the related art.

Further, in the connector 10 according to the embodiment of the present disclosure, the bottom plate 72A of the twisted wire holding portion 72 is disposed at the position closer to the axis C1 of the twisted cable 20 than the bottom plate 71A of the cable holding portion 71. In other words, the bottom plate 72A and the bottom plate 71A are stepped in order to make the axes C1 and C2 of the twisted cable 20 coaxial. Therefore, for example, when the bottom plate 72A and the bottom plate 71A are formed along the same plane, the electric wire 21 is bent such that a surface of the inner conductor 24 of the twisted cable 20 is along the same plane as the surface of the outer insulator 23 corresponding to a thickness dimension of the outer insulator 23.

In this case, when the outer insulator 23 is pulled in the direction away from the outer housing 60, the inner insulator 25 of the bent portion of the electric wire 21 bites into the bottom plate 72A and the crimping piece 72B of the twisted wire holding portion 72. Accordingly, the inner conductor 24 may come into contact with the twisted wire holding portion 72, which causes the electric wires 21 and 21 to be short-circuited. However, according to the connector 10 according to the embodiment of the present disclosure, the bottom plate 72A of the twisted wire holding portion 72 is disposed at the position closer to the axis of the twisted cable 20 than the bottom plate 71A of the cable holding portion 71. Therefore, even when the outer insulator 23 is pulled in the direction away from the outer housing 60, the problem that the electric wires 21 and 21 are short-circuited does not occur, and good connectivity can be reliably maintained.

According to the connector 10 according to the embodiment of the present disclosure, the crimping pieces 54 of the outer terminal 50 are crimped to the come-off prevention portion 73 of the ferrule 70, and the crimping pieces 55 of the outer terminal 50 are crimped to the cable holding portion 71. Therefore, the integrated cable holding portion 71 and twisted wire holding portion 72 are fixed to the outer terminal 50 via the come-off prevention portion 73. According to the connector 10 of the embodiment of the invention, the cable holding portion 71 and the twisted wire holding portion 72 are firmly fixed to the outer terminal 50 via the ferrule 70, and even when the outer insulator 23 is pulled in the direction away from the outer housing 60, good connectivity can be reliably maintained.

According to the ferrule 70 of the embodiment of the present disclosure, the cable holding portion 71 that holds the outer insulator 23, and the twisted wire holding portion 72 that collectively holds the inner insulators 25 are integrally provided by the ferrule 70. Therefore, in other words, the twisted wire 22 and the outer insulator 23 are integrally held. Therefore, according to the ferrule 70 of the embodiment of the present disclosure, even when the outer insulator 23 is pulled in the direction away from the outer housing 60, a contact margin of the inner terminal 30 with respect to a terminal of another connector can be maintained, and thus the electrical connectivity can be reliably maintained as compared with the related art.

### Second Embodiment

Next, the connector 10 of a second embodiment will be described. A significant difference between the first embodiment and the second embodiment is a configuration of a ferrule 70B. The inner terminal 30, the inner housing 40, the outer terminal 50, and the outer housing 60 constituting the connector 10 are the same as those of the first embodiment, and thus detailed description thereof will be omitted here.

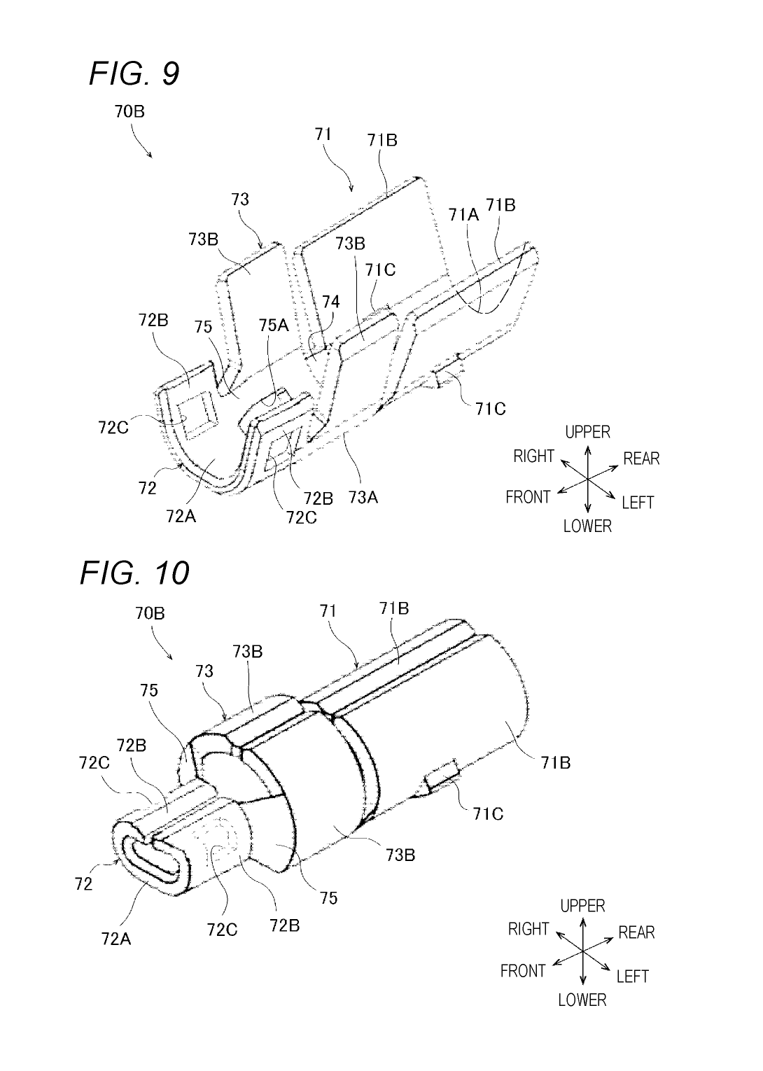

As illustrated in FIGS. 9 and 10, the ferrule 70B includes the cable holding portion 71, the twisted wire holding portion 72, the come-off prevention portion 73, the first coupling portion 74, and the second coupling portion 75. The cable holding portion 71, the come-off prevention portion 73, the first coupling portion 74, and the second coupling portion 75 are the same as those in the first embodiment, and thus the detailed description thereof will be omitted here. Similar to the first embodiment, the twisted wire holding portion 72 has a substantially U shape, including the bottom plate 72A and the pair of crimping pieces 72B and 72B. In the second embodiment, through holes 72C and 72C are provided in the pair of crimping pieces 72B and 72B, respectively.

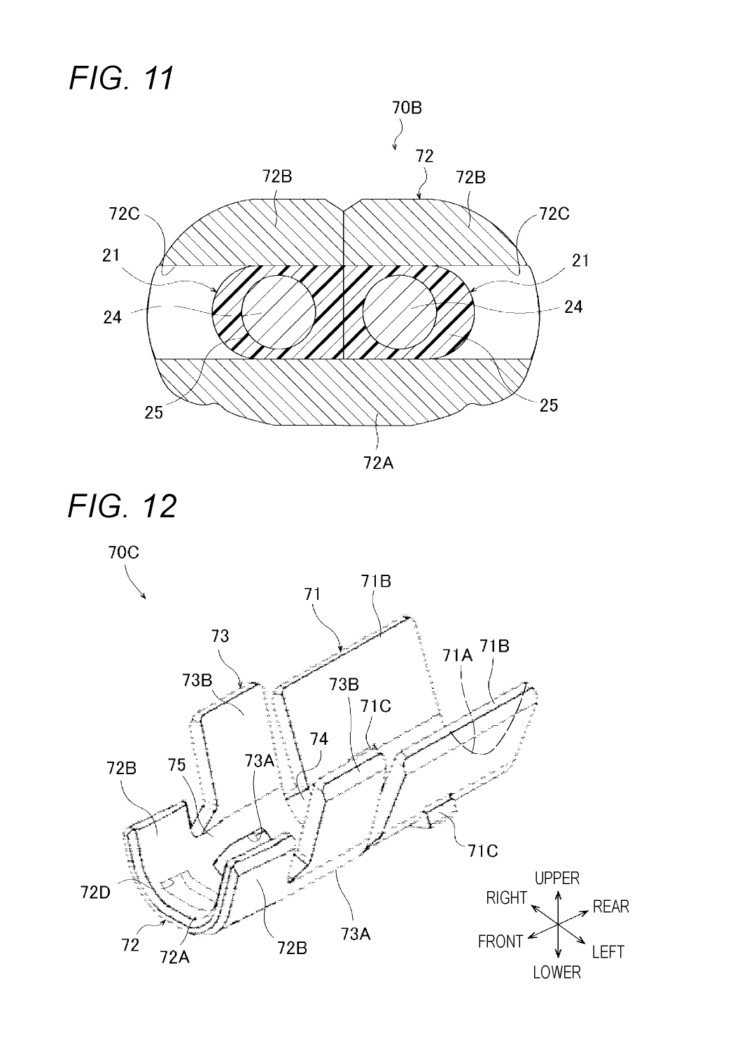

According to the first embodiment, the twisted wire 22 is held by the twisted wire holding portion 72. The inner insulators 25 of the twisted cable 20 are collectively held. Therefore, the fixing force is improved, but the characteristic impedance is reduced, which adversely affects the transmission characteristics. In the second embodiment, through holes 72C and 72C are provided in the pair of crimping pieces 72B and 72B. The metal covering the twisted wire 22 can be reduced in size by the through holes 72C and 72C, and adverse effects on the transmission characteristics can be reduced. In addition, as illustrated in FIG. 11, the inner insulator 25 escapes (swells) toward the through holes 72C and 72C due to the crimping of the pair of crimping pieces 72B and 72B. Accordingly, the inner insulators 25 of the twisted wire 22 bite into and are caught by the through holes 72C and 72C, and thus it is possible to control a reduction in fixing force due to the through holes 72C and 72C.

### Third Embodiment

Next, the connector 10 of a third embodiment will be described. A significant difference between the first embodiment and the third embodiment is a configuration of a ferrule 70C. The inner terminal 30, the inner housing 40, the outer terminal 50, and the outer housing 60 constituting the connector 10 are the same as those of the first embodiment, and thus detailed description thereof will be omitted here.

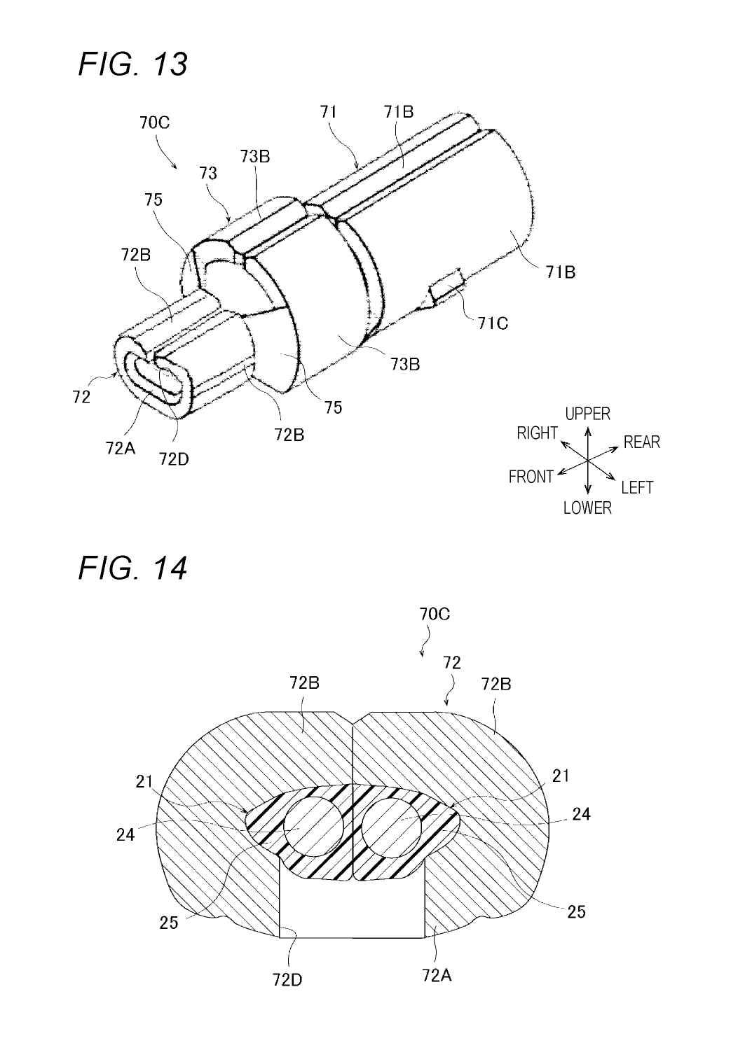

As illustrated in FIGS. 12 and 13, the ferrule 70C includes the cable holding portion 71, the twisted wire holding portion 72, the come-off prevention portion 73, the first coupling portion 74, and the second coupling portion 75. The cable holding portion 71, the come-off prevention portion 73, the first coupling portion 74, and the second coupling portion 75 are the same as those in the first embodiment, and thus the detailed description thereof will be omitted here. Similar to the first embodiment, the twisted wire holding portion 72 has a substantially U shape, including the bottom plate 72A and the pair of crimping pieces 72B and 72B. In the third embodiment, a through hole 72D is provided in the bottom plate 72A.

The metal covering the twisted wire 22 can be reduced in size by the through hole 72D, and the adverse effects on the transmission characteristics can be reduced. In addition, as illustrated in FIG. 14, the inner insulator 25 escapes (swells) toward the through hole 72D due to the crimping of the pair of crimping pieces 72B and 72B. Accordingly, the inner insulators 25 of the twisted wire 22 bite into and are caught by the through hole 72D, and thus it is possible to control a reduction in fixing force due to the through hole 72D.

### Fourth Embodiment

Next, the connector 10 of a fourth embodiment will be described. A significant difference between the first embodiment and the fourth embodiment is a configuration of a ferrule 70D. The inner terminal 30, the inner housing 40, the outer terminal 50, and the outer housing 60 constituting the connector 10 are the same as those of the first embodiment, and thus detailed description thereof will be omitted here.

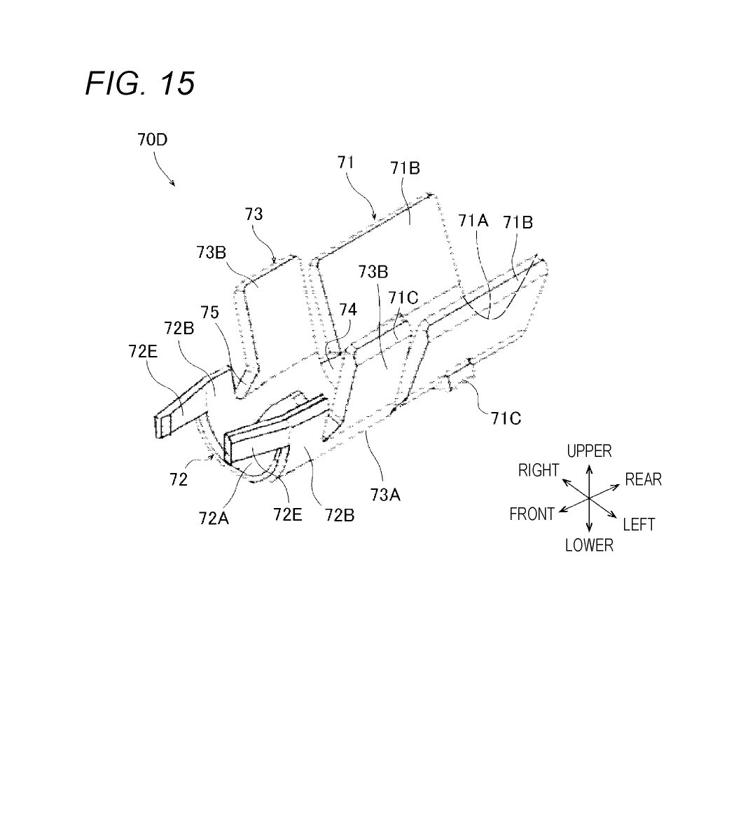

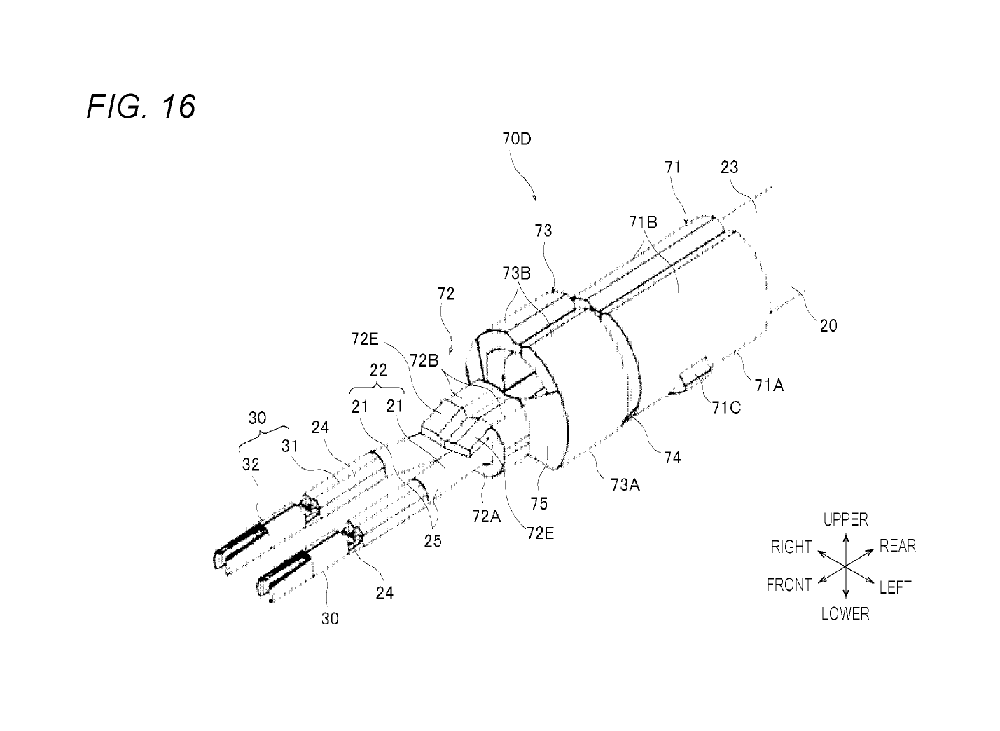

As illustrated in FIGS. 15 and 16, the ferrule 70D includes the cable holding portion 71, the twisted wire holding portion 72, the come-off prevention portion 73, the first coupling portion 74, and the second coupling portion 75. The cable holding portion 71, the come-off prevention portion 73, the first coupling portion 74, and the second coupling portion 75 are the same as those in the first embodiment, and thus the detailed description thereof will be omitted here. Similar to the first embodiment, the twisted wire holding portion 72 has a substantially U shape, including the bottom plate 72A and the pair of crimping pieces 72B and 72B. In the fourth embodiment, the pair of crimping pieces 72B and 72B are provided with a pair of biting prevention pieces 72E protruding toward a distal end of the inner terminal 30. The pair of biting prevention pieces 72E protrude from upper ends of the pair of crimping pieces 72B and 72B.

In the twisted wire 22, the pair of electric wires 21 and 21 are twisted. Therefore, the pair of electric wires 21 and 21 are twisted, and when the twisted wire holding portion 72 is crimped, the electric wire 21 may be bitten by the pair of crimping pieces 72B and 72B. When the electric wire 21 is bitten, the electric wire 21 and the outer terminal 50 may be short-circuited. In the fourth embodiment, the biting prevention pieces 72E are provided to prevent such biting of the electric wire 21.

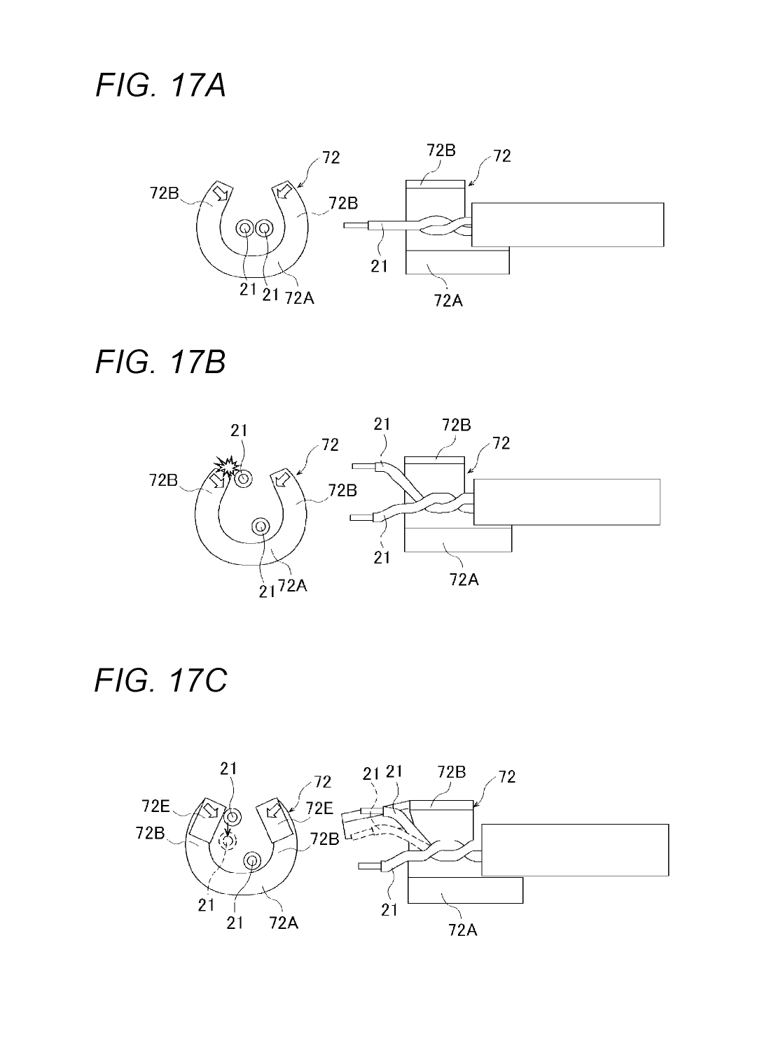

Next, an operation of the biting prevention pieces 72E at the time of crimping the pair of crimping pieces 72B and 72B will be described with reference to FIGS. 17A to 17C.

As illustrated in FIG. 17A, the pair of electric wires 21 and 21 are untwisted and mounted on the bottom plate 72A, and distal ends of the pair of crimping pieces 72B and 72B are brought close to each other. At this time, if the electric wire 21 is twisted, the electric wire 21 may protrude toward the distal ends of the pair of crimping pieces 72B and 72B as illustrated in FIG. 17B. In the present embodiment, as illustrated in FIG. 17C, the electric wire 21 directed toward the distal ends of the pair of crimping pieces 72B and 72B comes into contact with the biting prevention piece 72E and is pushed down toward the bottom plate 72A. Accordingly, it is possible to prevent the electric wire 21 from being bitten between the pair of crimping pieces 72B and 72B.

### Other Embodiments

The present disclosure is not limited to the above embodiments, and various modifications can be adopted within the scope of the present disclosure. For example, the present disclosure is not limited to the above embodiments, and modifications, improvements, and the like can be made as appropriate. In addition, materials, shapes, dimensions, numbers, arrangement positions, and the like of the components in the above embodiments are freely selected and are not limited as long as the present disclosure can be implemented.

In the above embodiment, the ferrule 70 is provided with the come-off prevention portion 73, but the present disclosure is not limited thereto. The provision of the come-off prevention portion 73 is not essential and may be omitted.

Here, features of the embodiments of the connector and the holding portion according to the present disclosure described above will be briefly summarized and listed in the following [1] to [8].

[1] A connector (10) to be attached to an end of a twisted cable (20) including a twisted wire (22) including a pair of electric wires (21, 21), and an outer insulator (23) covering the twisted wire (22), in which the electric wire (21) includes an inner conductor (24) and an inner insulator (25) covering the inner conductor (24), and the connector (10) includes: a pair of inner terminals (30, 30) respectively connected to the inner conductors (24, 24) of the pair of electric wires (21, 21); an inner housing (40) collectively covering the pair of inner terminals (30, 30); an outer terminal (50) covering the inner housing (40); and a holding portion (70) integrally provided with a cable holding portion (71) that holds the outer insulator (23), and a twisted wire holding portion (72) that collectively holds the inner insulators (25) of the pair of electric wires (21, 21) exposed from a distal end of the outer insulator (23) of the twisted cable (20).

According to the connector (10) having the above configuration [1], the cable holding portion (71) that holds the outer insulator (23) and the twisted wire holding portion (72) that collectively holds the inner insulators (25) are integrally provided by the holding portion (70). In other words, the twisted wire (22) and the outer insulator (23) are integrally held. Therefore, even when the outer insulator (23) is pulled in a direction away from the outer housing (60), a contact margin of the inner terminal (30) with respect to a terminal of another connector can be maintained, and thus the electrical connectivity can be reliably maintained as compared with the related art.

[2] The connector (10) according to [1], in which the cable holding portion (71) includes a first bottom plate (71A) on which the twisted cable (20) is mounted, and first crimping pieces (71B, 71B) that are erected from both sides of the first bottom plate (71A) in a width direction and that crimp the outer insulator (23), the twisted wire holding portion (72) includes a second bottom plate (72A) on which the pair of electric wires (21, 21) are mounted, and second crimping pieces (72B, 72B) that are erected from both sides of the second bottom plate (72A) in the width direction and that collectively crimp the inner insulators (25) of the pair of electric wires (21, 21), and the second bottom plate (72A) is disposed at a position closer to an axis of the twisted cable (20) than the first bottom plate (71A).

According to the connector (10) of the above [2], the second bottom plate (72A) of the twisted wire holding portion (72) is disposed at the position closer to the axis of the twisted cable (20) than the first bottom plate (71A) of the cable holding portion (71), and thus even when the outer insulator (23) is pulled in the direction away from the outer housing (60), the above problem that the electric wires (21, 21) are short-circuited does not occur, and good connectivity can be reliably maintained.

[3] The connector (10) according to [1], in which the holding portion (70) further includes a tubular come-off prevention portion (73) provided between the cable holding portion (71) and the twisted wire holding portion (72) and having an outer diameter larger than that of the cable holding portion (71), and the outer terminal (50) includes a third crimping piece (54) to be crimped to the come-off prevention portion (73) and a fourth crimping piece (55) to be crimped to the cable holding portion (71).

According to the connector (10) having the above configuration [3], the cable holding portion (71) and the twisted wire holding portion (72) are firmly fixed to the outer terminal (50) via the holding portion (70), and even when the outer insulator (23) is pulled in the direction away from the outer housing (60), good connectivity can be reliably maintained.

[4] The connector (10) according to [1], in which the twisted wire holding portion (72) is provided with through holes (72C, 72D). According to the connector (10) having the above configuration [4], a metal covering the twisted wire (22) can be reduced in size by the through holes (72C, 72D), and adverse effects on the transmission characteristics can be reduced. In addition, the inner insulators (25) bite into and are caught by the through holes (72C, 72D), and thus it is possible to control a reduction in fixing force due to the through holes (72C, 72D).

[5] The connector (10) according to [4], in which the twisted wire holding portion (72) includes a second bottom plate (72A) on which the pair of electric wires (21, 21) are mounted, and a pair of second crimping pieces (72B, 72B) that are erected from both sides of the second bottom plate (72A) in a width direction and that collectively crimp the inner insulators (25) of the pair of electric wires (21, 21), and the through holes (72C) are provided in the pair of second crimping pieces (72B, 72B), respectively.

According to the connector (10) having the above configuration [5], a metal covering the twisted wire (22) can be reduced in size by the through hole (72C), and the adverse effects on the transmission characteristics can be reduced. In addition, the inner insulators (25) bite into and are caught by the through holes (72C), and thus it is possible to control a reduction in fixing force due to the through holes (72C).

[6] The connector (10) according to [4], in which the twisted wire holding portion (72) includes a second bottom plate (72A) on which the pair of electric wires (21, 21) are mounted, and a pair of second crimping pieces (72B, 72B) that are erected from both sides of the second bottom plate (72A) in a width direction and that collectively crimp the inner insulators (25) of the pair of electric wires (21, 21), and the through hole (72D) is provided in the second bottom plate (72A).

According to the connector (10) having the above configuration [6], a metal covering the twisted wire (22) can be reduced in size by the through hole (72D), and the adverse effects on the transmission characteristics can be reduced. In addition, the inner insulators (25) bite into and are caught by the through hole (72D), and thus it is possible to control a reduction in fixing force due to the through hole (72D).

[7] The connector (10) according to [1], in which the twisted wire holding portion (72) includes a second bottom plate (72A) on which the pair of electric wires (21, 21) are mounted, and a pair of second crimping pieces (72B, 72B) that are erected from both sides of the second bottom plate (72A) in a width direction and that collectively crimp the inner insulators (25) of the pair of electric wires (21, 21), and the pair of second crimping pieces (72B, 72B) are provided with a biting prevention piece (72E) protruding toward a distal end of the inner terminal (30).

According to the connector (10) having the above configuration [7], it is possible to prevent the electric wire (21) from being bitten between the pair of crimping pieces (72B, 72B).

[8] A holding portion (70) to be attached to an end of a twisted cable (20) including a twisted wire (22) including a pair of electric wires (21, 21), and an outer insulator (23) covering the twisted wire (22), in which the electric wire (21) includes an inner conductor (24) and an inner insulator (25) covering the inner conductor (24), and the holding portion (70) is integrally provided with a cable holding portion (71) that holds the outer insulator (23), and a twisted wire holding portion (72) that collectively holds the inner insulators (25, 25) of the pair of electric wires (21, 21) exposed from a distal end of the outer insulator (23) of the twisted cable (20). According to the holding portion (70) having the above configuration [8], even when the outer insulator (23) is pulled in a direction away from the outer housing (60), a contact margin of the inner terminal (30) with respect to a terminal of another connector can be maintained, and thus the electrical connectivity can be reliably maintained as compared with the related art.

What is claimed is:

1. A connector to be attached to an end of a twisted cable including a twisted wire having a pair of electric wires, and an outer insulator covering the twisted wire, wherein
the electric wire includes an inner conductor and an inner insulator covering the inner conductor, and
the connector comprises:
a pair of inner terminals respectively connected to the inner conductors of the pair of electric wires;
an inner housing collectively covering the pair of inner terminals;
an outer terminal covering the inner housing; and
a holding portion integrally provided with a cable holding portion that holds the outer insulator, and a twisted wire holding portion that collectively holds the inner insulators of the pair of electric wires exposed from a distal end of the outer insulator of the twisted cable.

2. The connector according to claim 1, wherein
the cable holding portion includes a first bottom plate on which the twisted cable is mounted, and first crimping pieces that are erected from both sides of the first bottom plate in a width direction and that crimp the outer insulator,
the twisted wire holding portion includes a second bottom plate on which the pair of electric wires are mounted, and second crimping pieces that are erected from both sides of the second bottom plate in the width direction and that collectively crimp the inner insulators of the pair of electric wires, and
the second bottom plate is disposed at a position closer to an axis of the twisted cable than the first bottom plate.

3. The connector according to claim 1, wherein
the holding portion further includes a tubular come-off prevention portion provided between the cable holding portion and the twisted wire holding portion and having an outer diameter larger than that of the cable holding portion, and
the outer terminal includes a third crimping piece to be crimped to the come-off prevention portion and a fourth crimping piece to be crimped to the cable holding portion.

4. The connector according to claim 1, wherein
the twisted wire holding portion is provided with through holes.

5. The connector according to claim 4, wherein
the twisted wire holding portion includes a second bottom plate on which the pair of electric wires are mounted, and a pair of second crimping pieces that are erected from both sides of the second bottom plate in a width direction and that collectively crimp the inner insulators of the pair of electric wires, and
the through holes are provided in the pair of second crimping pieces, respectively.

6. The connector according to claim 4, wherein
the twisted wire holding portion includes a second bottom plate on which the pair of electric wires are mounted, and a pair of second crimping pieces that are erected from both sides of the second bottom plate in a width direction and that collectively crimp the inner insulators of the pair of electric wires, and
the through hole is provided in the second bottom plate.

7. The connector according to claim 1, wherein
the twisted wire holding portion includes a second bottom plate on which the pair of electric wires are mounted, and a pair of second crimping pieces that are erected from both sides of the second bottom plate in a width direction and that collectively crimp the inner insulators of the pair of electric wires, and
the pair of second crimping pieces are provided with a biting prevention piece protruding toward a distal end of the inner terminal.

8. A holding portion to be attached to an end of a twisted cable including a twisted wire having a pair of electric wires, and an outer insulator covering the twisted wire, wherein
the electric wire includes an inner conductor and an inner insulator covering the inner conductor, and
the holding portion is integrally provided with a cable holding portion that holds the outer insulator, and a twisted wire holding portion that collectively holds the inner insulators of the pair of electric wires exposed from a distal end of the outer insulator of the twisted cable.
